(19) United States
(12) Patent Application Publication
(10) Pub. No.: US 2013/0329411 A1
(43) Pub. Date: Dec. 12, 2013

(54) TWO PIECE FOCUSING OPTIC FOR FLASHLIGHT

(71) Applicant: COAST CUTLERY COMPANY, Portland, OR (US)

(72) Inventors: Gregory David Windom, Portland, OR (US); Kin Pak Leung, Kowloon (HK)

(73) Assignee: COAST CUTLERY COMPANY, Portland, OR (US)

(21) Appl. No.: 13/710,820

(22) Filed: Dec. 11, 2012

Related U.S. Application Data
(63) Continuation-in-part of application No. 13/490,278, filed on Jun. 6, 2012.

(51) Int. Cl. F21L 4/04; F21V 13/04; F21L 4/00

(52) U.S. Cl. CPC F21L 4/04; F21L 4/00; F21V 13/04
USPC 362/188; 362/187; 362/208

(57) ABSTRACT

The present disclosure relates to a focusing optic for shaping a beam of light from a light source, such as a light emitting diode (LED), for example in a flashlight or other lighting unit. In various embodiments, the focusing optic includes a central focusing element configured to direct a light beam from an LED in a desired direction; a side wall extending from the central focusing element, wherein the side wall is configured to form a rear void for receiving the LED; and an annular ring portion extending from the side wall and surrounding the central focusing element, wherein the annular ring portion is adapted to reflect light in a desired direction. In some embodiments, the side wall and annular ring portion together define a thickness dimension that varies less than 20% over the lens body.

### CROSS REFERENCE TO RELATED APPLICATIONS

The present application is a continuation-in-part of U.S. patent application Ser. No. 13/490,278, filed Jun. 6, 2012, titled “FOCUSING OPTIC FOR FLASHLIGHT,” the entire specification of which is hereby incorporated by reference in its entirety for all purposes, except those sections, if any, that are inconsistent with this specification.

### TECHNICAL FIELD

The present disclosure relates to a focusing optic for shaping a beam of light from a light source, such as a light emitting diode (LED), for example in a flashlight or other lighting unit. In various embodiments, the lens may be combined with an adjustment mechanism for varying the focus of the beam of light.

### BACKGROUND

Lenses for flashlights and other lighting units have been provided in a variety of forms, generally having in common a shape that is symmetrical about an axis along which the light is directed, e.g., the optical axis. Several such lenses have included a hole, such as a rear void, in the back side of the lens adjacent a light source. Within the hole, the light source may be adjusted in position along the optical axis. Adjustment of the light source's position relative to the rear hole of the lens enables variance of a light beam emerging from a front face of the lens. Typically, lenses are limited in their capacity to combine a maximum intensity for a spot beam with a substantial uniformity for a wide beam.

Such lenses typically also were provided with a central convex lens surface on a front face combined with at least one additional convex surface where the light was either received into the lens, reflected within the lens, or emitted from the lens. Without being bound by theory, the additional convex surface may have been deemed necessary for a proper focusing of light from the source into a beam. Such lenses were alternatively provided with light-receiving, reflecting, and emitting surfaces that were flat as viewed in cross-section. Such flat surfaces were also likely deemed necessary for light-focusing or manufacturing purposes.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a cross-sectional view of an example of a focusing optic;

FIG. 2 illustrates a cross-sectional view of the focusing optic illustrated in FIG. 1, wherein the optic is housed within a bezel incorporating a light source that is adjustable in position along an optical axis;

FIGS. 3A and 3B show the light refraction and reflection to form varying beams (FIG. 3A illustrates a wide or flood beam and FIG. 3B illustrates a narrow or spot beam) as the light source is moved with respect to the rear wall of the optic;

FIGS. 4A-4D are four cross-sectional views of a bezel and a focusing optic, showing a threaded adjustable bezel with the light source in a wide beam or flood position (FIG. 4A) and a narrow or spot beam position (FIG. 4B), and a slidably-adjustable bezel with the light source in a wide beam or flood position (FIG. 4C) and in a narrow or spot beam position (FIG. 4D);

FIG. 5 illustrates a cross-sectional view of an example of a flashlight configured for use with the focusing optic of FIG. 1; and

FIGS. 6A and 6B show a perspective view (FIG. 6A) and a cross sectional view (FIG. 6B) of an embodiment in which the lens includes two parts: a central portion and a separate annular ring portion, all in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments herein provide focusing optics for flashlights and other lighting devices. In some embodiments, a focusing optic as disclosed herein may be combined with a light source and an adjustment mechanism that allows focusing of the light from the source. In various embodiments, a light emitting diode or LED may be used as the light source, although other light sources, such as incandescent or fluorescent bulbs may be used.

In various embodiments, the lens may be generally circular, and may have a front face configured to emit light and a rear face configured to receive light from the light source. In various embodiments, the lens may be shaped to direct light from the light source in a desired direction, and may have a generally concave front face and a generally convex rear face, although portions of the front face may also be convex, and portions of the back face may be concave.

In various embodiments, the lens may include two or more distinct portions, such as a central portion surrounded by an annular ring, and the curvature of each of these two portions may vary independently of one another, depending on the desired beam-shaping properties of the lens and other factors. In various embodiments, the central portion may include a central focusing element, and in some embodiments, the central focusing element may be set off from the annular ring portion by a side wall that is configured to form a rear void in the rear face of the lens. In various embodiments, the central focusing element, side wall, and annular ring may be a single piece, whereas in other embodiments, the central portion and the annular ring portion may be separate components. In various embodiments, the rear void formed by the central focusing element and side wall may be sized and shaped to accommodate a light source and/or at least of a portion of the light source base or pedestal.

The annular ring portion may be generally curved, and in various embodiments, a surface, such as a front or rear surface of the annular ring portion may be coated with a reflective coating and configured to function as a reflector. In other embodiments, particularly when the lens is a two-part lens, the annular ring portion may be made from a separate piece of the same material, or a different material than the central portion, for example, an injection-molded, vacuum-metalized polycarbonate plastic, acrylate polymer, or acrylic, a metallic material, such as machined aluminum, or any other material having reflective properties. Although the examples illustrated herein depict single-piece focusing lenses and two-part lenses wherein the central portion includes the central focusing element and the side wall, one of skill in the art will appreciate that in other embodiments, the central focusing element may be separate from the rest of the lens, which may include the side wall and annular ring portions, or a three-part lens may be used.

In some embodiments, outside of the central focusing element, the thickness of the lens may vary very little in the different areas. In various embodiments, the thickest portion of the lens may be the central focusing element, which may be several times thicker than the surrounding lens portions in order to disperse the light in a wide beam when the light source is spaced closely behind the lens, within the rear void. In some embodiments, the thickness of this central focusing element may be varied in order to achieve a desired beam focusing effect. In various embodiments, outside the central focusing element, the rest of the lens may have a relatively uniform thickness, varying in thickness from about 0% to about 20% across the lens surface, such as about 18%, about 15%, about 12%, about 10%, about 9%, about 8%, about 7%, about 6%, about 5%, about 4%, about 3%, about 2%, or about 1%. Without being bound by theory, it is believed that the thin profile of the disclosed lenses permits a more efficient transfer of light through the lens as compared to conventional lenses, and may enable a lower-powered light source to be used to achieve a beam with equivalent or greater brightness as compared to conventional flashlight lenses. Furthermore, for single-piece embodiments, the one-piece construction may simplify assembly steps and thereby reduce the cost required to produce the light. In other embodiments, for example, a two-piece lens may be used in order to simplify machining or metalizing of the reflector, or to reduce manufacturing costs compared to those associated with a single-piece system. In a two-piece lens system, the annular ring portion may have a profile with a thickness dimension similar to that of the side wall portion, or it may be thicker or thinner, depending on the application.

In some embodiments, the lens may be housed in a flashlight bezel, which may couple to or form a portion of a body or housing member. In some embodiments, the body or housing member may include a light source fixably coupled thereto, and the bezel may be adjustable, for example by sliding or twisting, with respect to the body or housing member. In some embodiments, this slidable or twistable adjustability may permit alteration of the distance between lens and light source, thus allowing the light beam to be adjusted from flood or wide bean to spot or narrow beam. In particular embodiments, the bezel may be adapted to couple to a body member that includes the LED fixed thereupon. In these embodiments, the distance between the lens and the LED may be adjusted by virtue of adjusting the position of the bezel on the body member, for instance via a threaded coupling or one or more O-rings. In other embodiments, the position of the light source may be adjustable within the body or bezel, and the system may include an adjustment mechanism for moving the light source relative to the lens, such as a switch, tab and slot, or any other mechanism known to those of skill in the art.

In some embodiments, the annular ring portion may define in cross-section an elliptical curve, and may include a light-reflecting surface, which may be configured to reflect the light that strikes it from within the lens body. In various embodiments, the annular ring portion, viewed internally of the lens body as a reflector, may define in cross-section a concave curve. In other embodiments, the annular ring portion viewed from outside the lens body may define a convex curve. In still other embodiments, the annular ring portion may be flat, when viewed in cross section.

In various embodiments, the central focusing element may include a front surface that may be convex, and so may include a forward-most point, typically at the center of the surface. In various embodiments, the annular ring portion of the front face of the lens body may extend forward to a front rim that is farther forward than the forward-most point of the front surface of the central portion, thus protecting the lens body from impact and abrasion. The lens body may further include an outer, front rim defining a chamfer between the annular surface and the side surface.

In various embodiments, the flashlight also may include a power supply, such as batteries or an AC-DC converter with electronics to condition a voltage waveform compatible with the LED. For example, in some embodiments, a pulse width modulator may be used to adjust the effective brightness of the LED.

In various embodiments, the lens body (or just the central portion, in some embodiments) may be formed from a single piece of solid, transparent material, such as glass, an acrylate polymer such as polymethyl methacrylate (PMMA), or a thermoplastic polymer, such as a polycarbonate plastic, molded or otherwise formed as a single piece. In some embodiments, the lens or central portion may be formed from a single piece of solid, injection-molded acrylic. In some embodiments, the central portion of the lens may be co-molded with the annular ring portion of the lens. In further embodiments, the lens may be co-molded with other parts, such as all or part of the bezel. Optionally, some portions of this integrated piece may be tinted or coated, for example with a light-reflecting or obstructing coating, and/or portions of the bezel may be painted or otherwise tinted to prevent light escape. In still other embodiments, the central portion of the lens, including the central focusing element and the side wall, may be formed from a transparent material, such as glass, an acrylate polymer such as PMMA, a thermoplastic polymer such as polycarbonate plastic, or injection-molded acrylic, and the annular ring portion may be formed from a reflective material, such as injection-molded, vacuum-metalized polycarbonate plastic, acrylate polymer, or acrylic, or from a metal, such as machined aluminum. In these embodiments, although the central portion and the annular ring portion are separate components, they may be configured to mate together and they may not move relative to one another during focusing of the light.

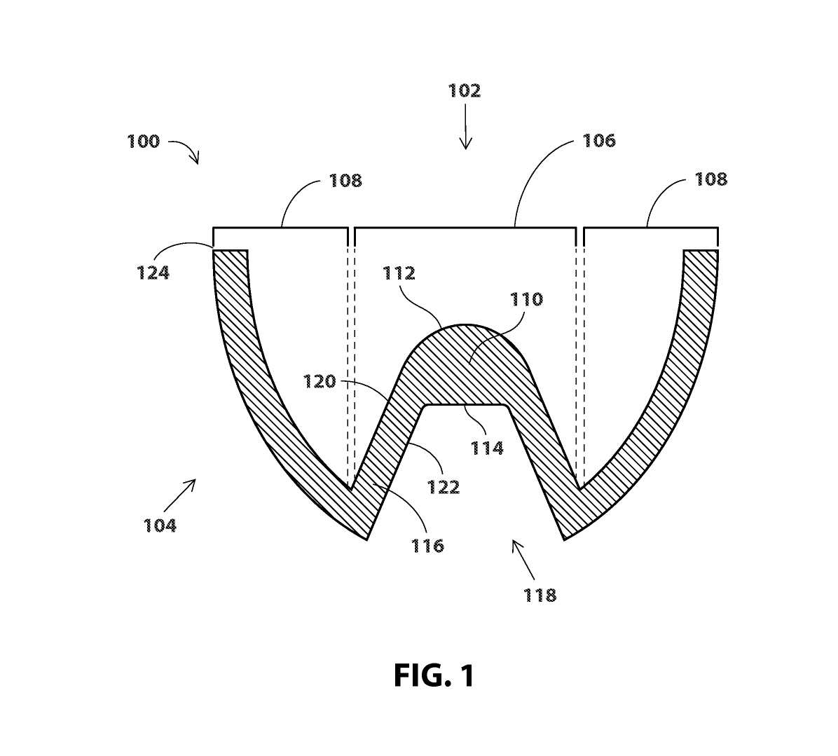

FIG. 1 illustrates a cross-sectional view of one example of a focusing lens, in accordance with various embodiments. In various embodiments, the lens body 100 may have a generally concave front face 102 and a generally convex rear face 104. In various embodiments, the lens body 100 may include a central portion 106, including a central focusing element 110 and a side wall 116, and an annular ring portion 108 surrounding the central portion 106.

In various embodiments, central portion 106 includes a central focusing element 110, which may be configured to direct light in a desired direction. In various embodiments, central focusing element 110 may include a convex front surface 112 and a flat rear surface 114, although in other embodiments, rear surface 114 may be flat or convex, depending on the desired focusing properties of the lens. In various embodiments, central focusing element 110 may be set off from annular ring portion 108 by a side wall 116 that may be configured to form a rear void 118 in the rear face 104 of the lens. In various embodiments, rear void 118 may be sized and shaped to accommodate a light source and/or at least of a portion of the light source base or pedestal (not shown). In various embodiments, side wall 116 may be flat as illustrated in FIG. 1, or it may have a slight elliptical curve, depending on the desired focusing properties of lens 100. Additionally, side wall 118 may have convex, flat, or concave front 120 and back 122 surfaces surfaces, as desired in order to achieve the desired light focusing properties. In one specific, non-limiting example, rear void 118 may have a substantially frustoconical shape.

In various embodiments, annular ring portion 108 may have a reflective front or back surface, and may be shaped in order to reflect light from the light source in a desired direction. In various embodiments, as described in greater detail below, central focusing element 110, side wall 116, and annular ring portion 108 may be configured to cooperate to direct light from a light source in a desired direction. Although a particular configuration of lens components is illustrated in FIG. 1, one of skill in the art will appreciate that other combinations of flat and/or curved lens surfaces may be substituted to fit a particular application and/or set of beam focusing requirements.

Additionally, although lens body 100 includes slight concavities and/or convexities in various portions, one of skill in the art will appreciate that the overall lens shape includes a generally concave front face 102, a generally convex rear face 104, a central focusing element 110, a side wall 116 configured to form a rear void 118, and an annular ring portion 108 configured to function as a reflector. Although the illustrated embodiment depicts central focusing element 110 as being continuous with side wall 116, one of skill in the art will appreciate that in other embodiments these features may be partially or completely discontinuous. In various embodiments, the overall thickness of the lens body 100, excluding central focusing element 110, when seen in cross section, is fairly uniform throughout lens body 100, despite being adapted to bend in and out of plane in order to achieve a desired focusing effect. In various embodiments, the thickness (T) of lens body 100, excluding central focusing element 110, may vary less than about 20% (for example, 15%, 10%, 5%, or 2%) over the entire width of lens body 100. For example, in one specific, non-limiting example, the thickness may vary by less than about 10% over the full width of lens body 100, excluding central focusing element 110, for example, 9%, 8%, 7%, 6%, 5%, 4%, 3%. 2%, 1%, or even 0%. In specific, non-limiting embodiments, a suitable lens thickness for a small-diameter lens may be about 2-3 mm, and a suitable thickness for a large-diameter lens may be 2-3 cm, or even more. In general, thickness (T) may be measured across a lens body in a direction generally perpendicular to any position on a front surface of the lens body, excluding the central focusing element.

In various embodiments, central portion 106 may include a convex front surface 112 defining a forward-most point. In various embodiments, convex front surface 112 may incorporate any of various curvatures, and in some embodiments, the curvature may be substantially arcuate with a radius of no more than about 4 mm for a small-diameter flashlight having an overall lens diameter of less than about 2 cm, for example a lens having an overall diameter of about 12 mm. One of skill in the art will appreciate that this central portion diameter may be generally proportionately larger for larger diameter lenses. For example, a large diameter lens of 5-10 cm may have a central portion having a diameter of 1-4 cm, for example about 1.5-2.5 cm. The measurements described with reference to the embodiments of the lens are merely exemplary. Those of ordinary skill in the art will readily understand that other measurements may be used without deviating from the scope of the disclosure.

In various embodiments, annular ring portion 108 of lens body 100 may extend forward to front rim 124. In various embodiments, front rim 124 may extend farther forward than the forward-most point of central portion 106. In various embodiments, front rim 124 may include a chamfer between annular ring portion 108 and front rim 124 of at least about 0.2-0.5 mm of width for a small diameter flashlight. In some embodiments, the chamfer may have a width selected for a desired lens size and operational characteristics, and, as examples only, may be about 1.5 mm, about 2.0 mm, about 2.5 mm, or about 3.0 mm in width for a larger diameter lens.

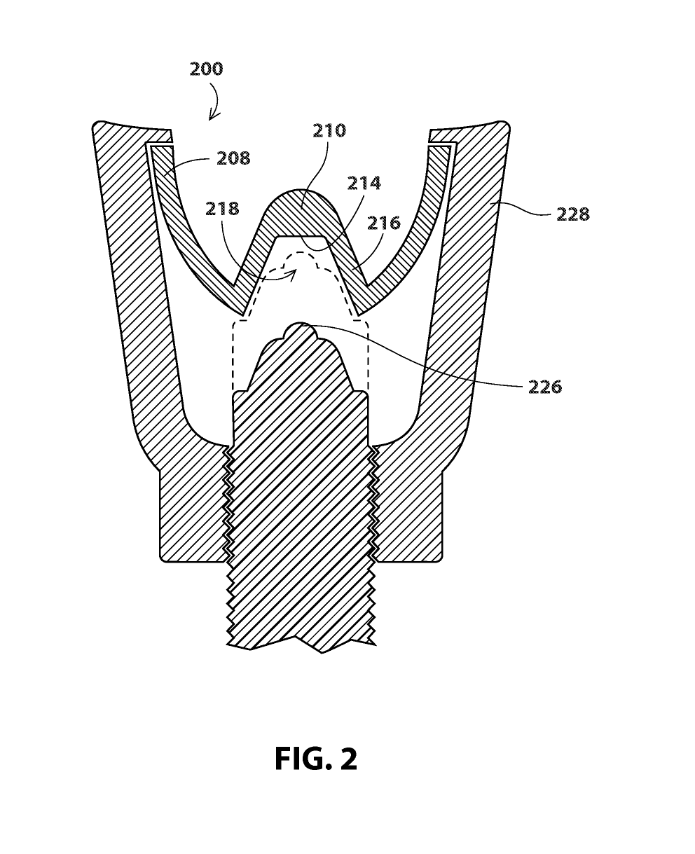

FIG. 2 illustrates a cross-sectional view of the lens body illustrated in FIG. 1, wherein the lens is housed within a bezel incorporating a light source that is adjustable in position along an optical axis, in accordance with various embodiments. As seen in FIG. 2, in various embodiments, lens 200 may be paired with a light source, such as LED 226, for example, that may be adjustable in position along an optical axis within the bezel 228, from a typical starting position, shown in solid line, through intermediate positions to a final position, indicated by the broken lines. In various embodiments, the adjustment may be continuous or it may be provided with stops or detents at selected positions. Any range of position adjustments may be incorporated as suited to the particular lens size, design, and desired beam variations. In some embodiments, the range is from about 3 mm to about 5 mm for a small-diameter flashlight, and as much as 2-3 cm or more for larger diameter lens systems.

In one specific, non-limiting example of a lens, e.g., for a small-sized lens system, the lens may have a width of about 8 mm, a thickness of about 2 mm, an inner diameter of about 3 mm, a chamfer width of about 1 mm, and a range of position adjustment of about 2 mm. Other combinations may be selected for desired operational characteristics and lens sizes. Typically such dimensional ratios may be varied by at least about ±10%.

In various embodiments, central focusing element 210 may interact with LED 226 in various manners dependent upon, for example, the position of LED 226. For instance, in various embodiments, when LED 226 is far away from central focusing element 210 (e.g., a narrow angle position), only a small fraction of the light may interact with central focusing element 210. Consequently, in various embodiments, central focusing element 210 may not noticeably influence narrow light distribution. Conversely, when LED 226 is near to rear surface 214 of central focusing element 210 (e.g., a wide angle position), central focusing element 210 may influence the beam pattern in a desired manner. Thus, in various embodiments, central focusing element 210 may enable wide angle light distribution, with little effect on narrow angle distribution. Thus, in various embodiments where LED 226 is in a forward position (e.g., within rear void 218 and close to rear surface 214 of central focusing element 210), the bulk of the light from LED 226 will pass through central focusing element 210, and will be directed in a wide beam pattern.

Conversely, in various embodiments when LED 226 is in a rearward position (e.g., toward the back of rear void 218 and spaced apart from rear surface 214 of rear void 218), only a small portion of the light from LED 226 will pass through central focusing element 210. Instead, light from LED 226 will pass through side wall 216, and it will reflect off of the reflective surface of annular ring portion 208 to be directed in a desired direction, for example in a narrow or spot beam.

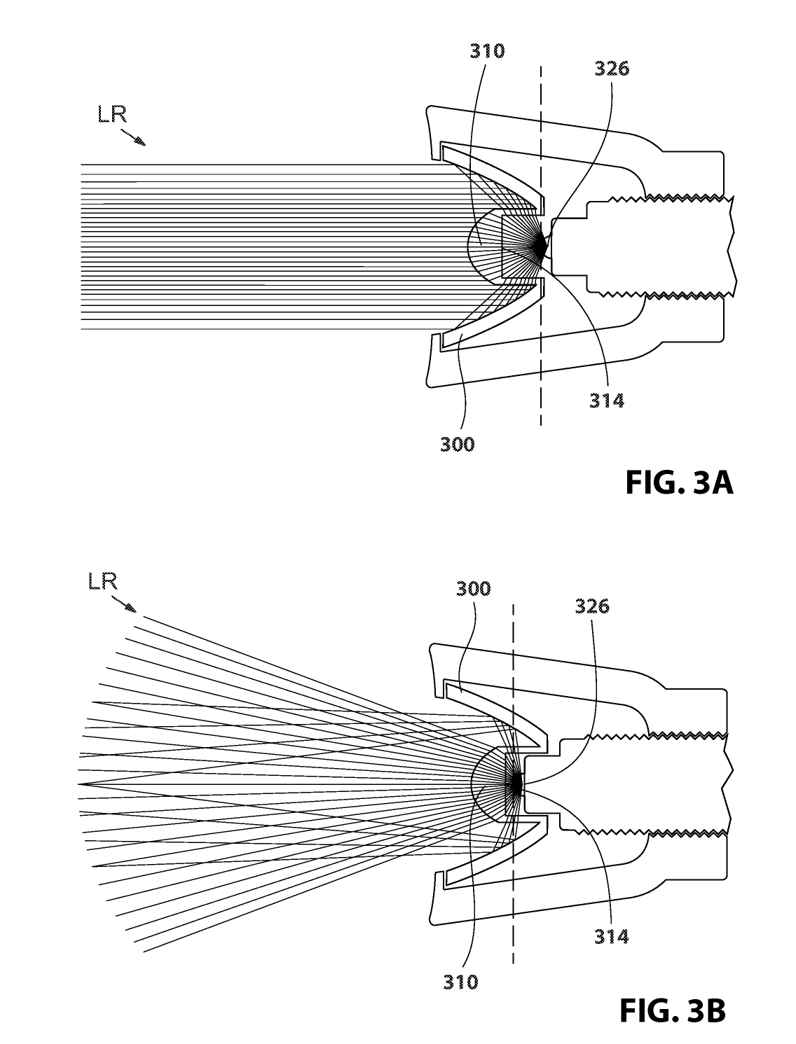

This phenomenon is illustrated in FIGS. 3A and 3B, which show the light refraction and reflection forming varying beams (FIG. 3A illustrates a wide or flood beam and FIG. 3B illustrates a narrow or spot beam) as LED 326 is moved with respect to rear surface 314 of central focusing element 310 of lens body 300, in accordance with various embodiments. As illustrated in FIGS. 3A and 3B, adjustment of the LED position relative to the lens may provide a beam ranging between a wide beam or flood light (see, e.g., FIG. 3A) and a narrow or spot beam (see, e.g., FIG. 3B). In various embodiments, a spot beam may provide about +/−3° of angular distribution at about 50% of maximum intensity. An example of a wide beam is a distribution with an angular range of about +/−45° over which the intensity is at least about 50% of the maximum or on-axis value. In accordance with various embodiments, the light may be varied from spot beam to wide beam with the adjustment in position of the LED being no more than about 3-50 mm, depending on the lens diameter. A representation of the light rays LR calculated for an example of a lens and LED configuration is shown in each of FIGS. 3A and 3B. As illustrated, in various embodiments, lens 300 may direct a substantial portion of light rays LR into the desired beam and a smaller portion of light rays LR may be expected to travel outside the desired beam.

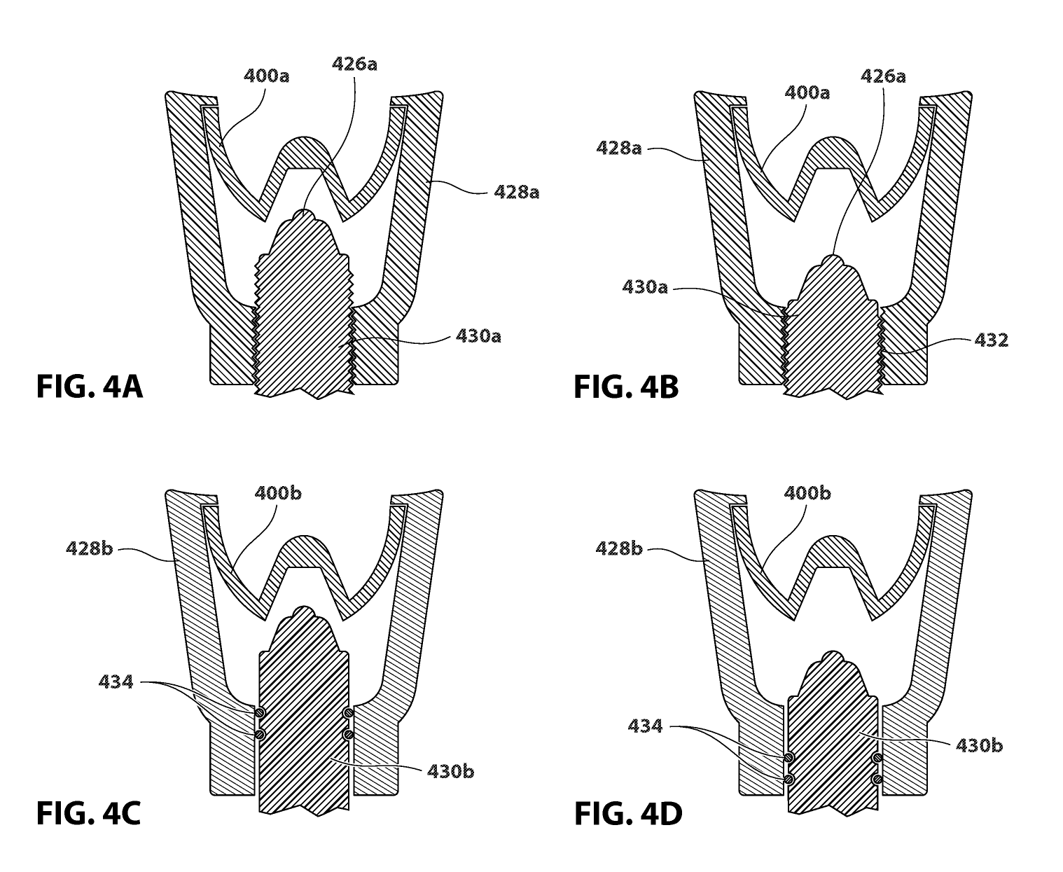

FIGS. 4A-4D are four cross-sectional views of a bezel and focusing optic for a flashlight, showing a threaded adjustable bezel with the light source in a wide beam or flood position (FIG. 4A) and a narrow or spot beam position (FIG. 4B), and a slidably-adjustable bezel with the light source in a wide beam or flood position (FIG. 4C) and in a narrow or spot beam position (FIG. 4D); in accordance with various embodiments. As illustrated, in various embodiments, as shown in FIGS. 4A and 4B, the system may include bezel 428a and a lens body 400a housed therein. In some embodiments, bezel 428a may be configured to couple to a body member 430a, which may include a light source, such as LED 426a. In some embodiments, the system may also include an adjustment mechanism, such as a threaded coupling or engagement 432 between bezel 428a and body member 430a, which may permit adjustment of the spacing between the light source and the lens, thus enabling focusing of the resulting light beam as described in detail above.

In other embodiments, as shown in FIGS. 4C and 4D, the system may include a lens 400b housed within a bezel 428b that may be slidably mounted on body member 430b. In some embodiments, the slidable mount may include one or more O-rings 434 that may facilitate adjustment of bezel 428b on body member 430b, which may permit adjustment of the spacing between LED 426b and lens 400b, thus enabling focusing of the resulting light beam, for instance to produce a spot beam or a flood beam. Although threaded and slidable mounts are illustrated, one of skill in the art will appreciate that any other suitable mechanism allowing a user to adjust the relative positions of the lens and light source may be used.

In various embodiments, body member 430a, 430b may include a heat sink member 436a, 436b adapted to disperse heat from the LED. In some embodiments, heat sink member 436a, 436b may be shaped to fit closely within rear void 418. Without being bound by theory, it is believed that maximizing the size of heat sink member 436a, 436b within rear void 418 may allow for better heat transfer away from LED 426a, 426b. In particular embodiments, at least a portion of heat sink member 436a, 436b may be frustoconical.

In various embodiments, the system may be adjusted with the adjustment mechanism as described in order to provide a light beam with a wide beam having a distribution with an angular range of about +/−45° over which the intensity is at least 50% of the maximum or on-axis value. For that wide beam, the system may provide a substantially uniform intensity between at least about +/−10° of angular distribution.

In some embodiments, bezel 428a, 428b may be provided with a grip-enhanced region, such as a region having grooves, ridges, swellings, textures, or the like, which may extend partially or completely around bezel 428a, 428b. In various embodiments, the grip-enhanced region may aid a user, e.g., in a one-handed adjustment of the focus of the beam by providing a convenient grip for the thumb and forefinger on bezel 428a, 428b while body member 430a, 430b is gripped by the other three fingers. In some embodiments, a control button may be provided on the flashlight body, e.g., at an end opposite bezel 428a, 428b, or on bezel 428a, 428b itself.

In various embodiments, body member 426a, 426b or other housing structures may be made from a metal such as aluminum or steel or a plastic such as ABS. Component materials may be selected to be compatible with lighting unit operation in harsh environments such as very high or very low ambient temperatures.

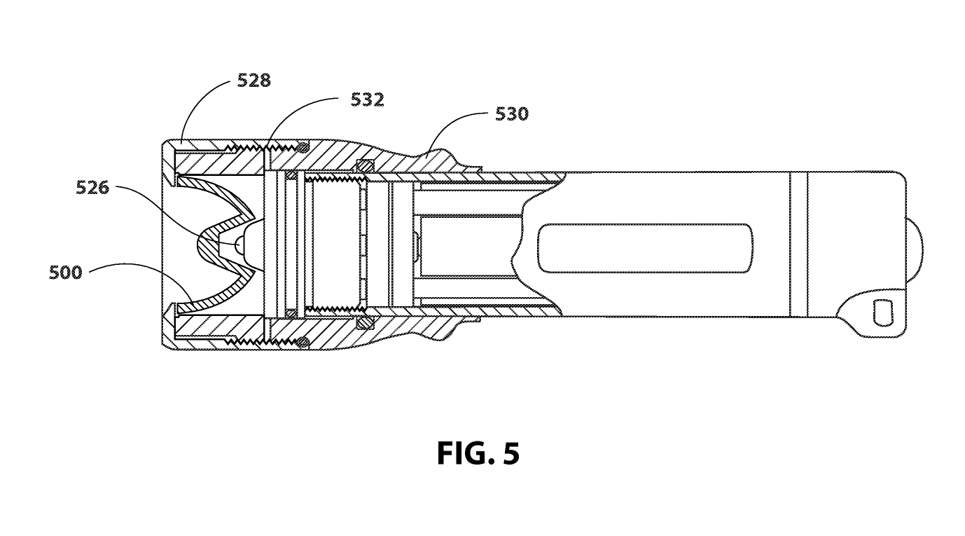

FIG. 5 illustrates a cross-sectional view of an example of a flashlight configured for use with a focusing optic, in accordance with various embodiments. In the illustrated embodiment, lens 500 is housed within a bezel 528 that couples to a body member 530 via a threaded engagement 532. In use, a user twists bezel 528 relative to body member 530, thus decreasing or increasing the distance between LED 526 and lens 500, and adjusting the light beam to a flood or wide beam, or to a narrow beam or spot light, as desired by the user. Although a threaded engagement mechanism is illustrated, one of skill in the art will appreciate that any other adjustment mechanism may substituted that allows a user to adjust the distance between lens 500 and LED 526.

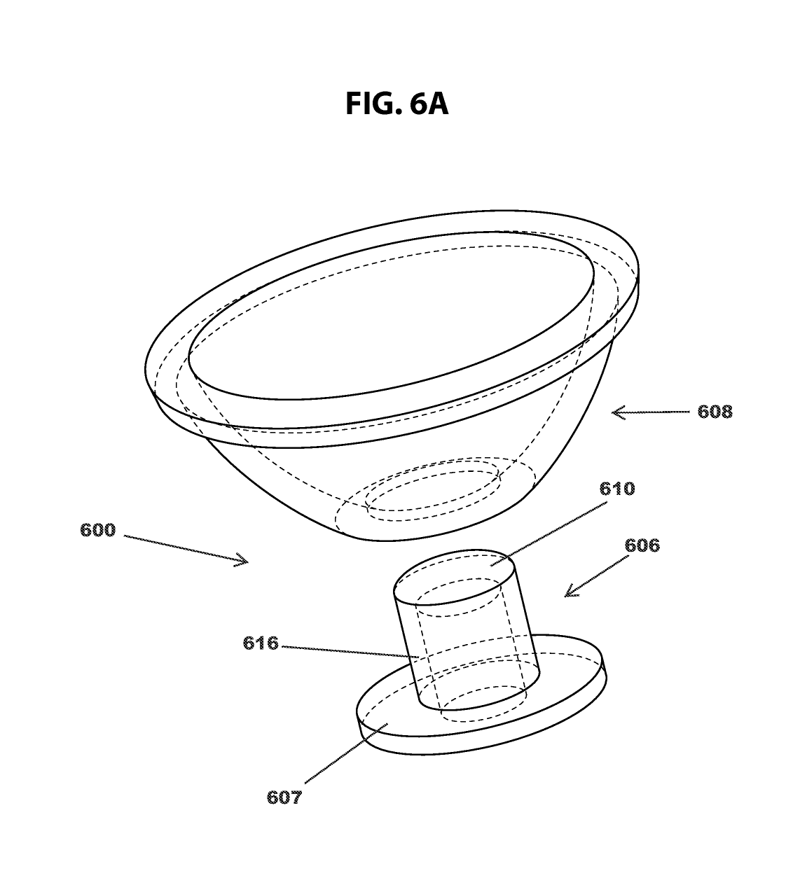

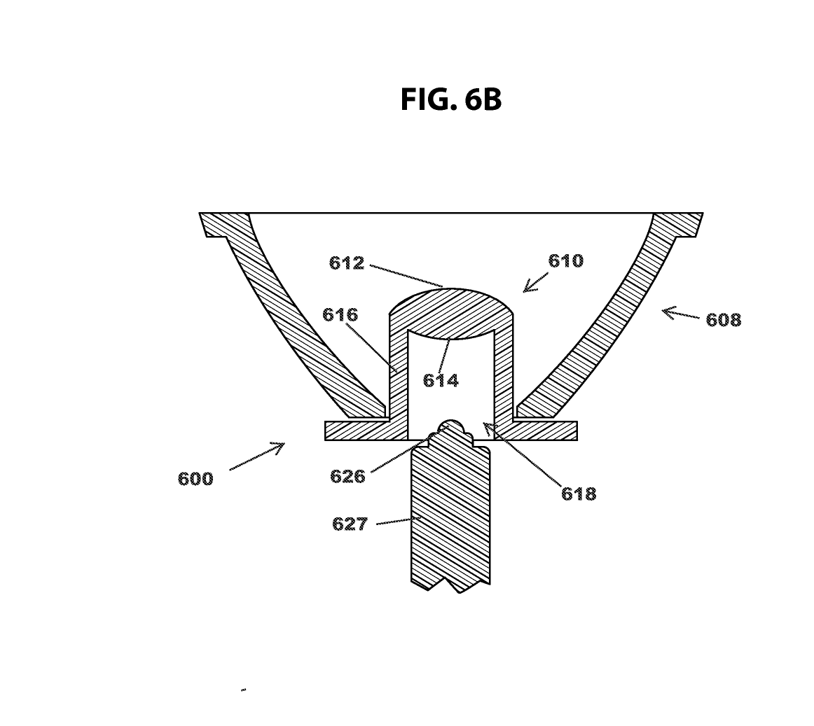

FIGS. 6A and 6B show a perspective view (FIG. 6A) and a cross sectional view (FIG. 6B) of another embodiment in which the lens includes two parts: a central portion and a separate annular ring portion, in accordance with various embodiments. In this embodiment, the lens body 600 may include a central portion 606, including a central focusing element 610 and a side wall 616, and the annular ring portion 608 may be a separate piece surrounding central portion 606. In some embodiments, central portion 607 may include a flange 607 or other coupling element that may be configured to engage and/or couple to or mate with annular ring portion 608. As described above, in various embodiments, when lens 600 is a two-part lens, central portion 606 may be formed from a transparent material, such as glass, an acrylate polymer such as PMMA, a thermoplastic polymer such as polycarbonate plastic, or injection-molded acrylic, and annular ring portion 608 may be formed from a separate piece of the same or a different material having reflective propoerties, such as injection-molded, vacuum-metalized polycarbonate plastic, acrylate polymer, or acrylic, or a metal or metalized material, such as machined aluminum.

As is true with the single-piece lens, in the illustrated two-piece lens embodiment, central portion 606 may include a central focusing element 610, which may be configured to direct light in a desired direction. As may be best seen in FIG. 6B, central focusing element 610 may include a convex front surface 612 and a convex, flat, or concave rear surface 614, depending on the desired focusing properties of the lens. In various embodiments, central focusing element 610 may be set off from annular ring portion 608 by a side wall 616 that may be configured to form a rear void 618 in the rear face of the lens. In various embodiments, rear void 618 may be sized and shaped to accommodate a light source 626 and/or at least of a portion of the light source base 627 or pedestal. In various embodiments, side wall 616 may be flat as illustrated in FIG. 6B, or it may have a slight elliptical curve, depending on the desired focusing properties of lens 600. In one specific, non-limiting example, rear void 618 may have a substantially frustoconical shape.

In various embodiments, annular ring portion 608 may have a reflective front or back surface, and may be shaped in order to reflect light from light source 626 in a desired direction. In various embodiments, as described in greater detail above, central focusing element 610, side wall 616, and annular ring portion 608 may be configured to cooperate to direct light from a light source in a desired direction.

As described above, in various embodiments, the overall thickness of the lens body 600, excluding central focusing element 610, when seen in cross section, may be fairly uniform throughout lens body 600, despite being adapted to bend in and out of plane in order to achieve a desired focusing effect. In some embodiments, such as in the illustrated embodiment, side wall 616 and annular ring portion 608 may have similar thickness dimensions, and in other embodiments, annular ring portion 608 may be thicker or thinner than side wall 616, depending on the application and the materials selected. Additionally, although central portion 610 and annular ring portion 608 are illustrated as having a particular size ratio relative to one another, one of skill in the art will appreciate that the diameters of the central portion and annular ring portion 608 may be varied in order to suit a particular application. For example, central portion 610 may be paired with a narrow annular ring portion 610 in a small diameter flashlight, and it may be paired with a much larger diameter annular ring portion in a large diameter flashlight.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A focusing optic for a flashlight, comprising:
a generally circular lens body having a generally concave front face and a generally convex rear face, wherein the lens body includes:
a central focusing element configured to direct a light beam from an LED in a desired direction, the central focusing element having a convex front surface and a rear surface;
a side wall extending from the central focusing element, wherein the side wall is configured to form a rear void for receiving the LED, and wherein the side wall is configured to direct the light beam in a desired direction; and
an annular ring portion configured to mate with and extend from the side wall and surrounding the central focusing element, wherein the annular ring portion is adapted to reflect light from the LED in a desired direction;
wherein the central focusing element and annular ring portion are configured to remain fixed relative to one another during focusing of the focusing optic.

2. The focusing optic of claim 1, wherein the annular ring portion is a separate component from the side wall and central focusing element.

3. The focusing optic of claim 1, wherein the rear void is sized and shaped to accommodate at least a portion of an LED heat sink member.

4. The focusing optic of claim 1, wherein the rear void has a substantially frustoconical shape.

5. The focusing optic of claim 3, wherein the LED is coupled to a heat sink, and wherein the heat sink has a substantially frustoconical portion adapted to fit within the rear void.

6. The focusing optic of claim 1, wherein the rear void is sized and shaped to allow a distance between the rear surface of the central focusing element and the LED to be adjusted.

7. The focusing optic of claim 6, wherein adjusting the distance between the rear surface of the central focusing element and the LED alters the focus of the light beam.

8. The focusing element of claim 7, wherein the central focusing element is adapted to receive substantially all of the light from the LED when the LED is moved adjacent to the rear surface of the central focusing element.

9. The focusing element of claim 7, wherein the central focusing element is adapted to direct the light beam in a wide beam pattern when the LED is moved adjacent to the rear surface of the central focusing element.

10. The focusing element of claim 7, wherein the side wall is configured to receive a portion of the light from the LED when the LED is spaced apart from the rear surface of the central focusing element.

11. The focusing element of claim 10, wherein the central focusing element and the side wall cooperate to direct the light beam in a narrow beam when the LED is spaced apart from the rear surface of the central focusing element.

12. The focusing element of claim 1, wherein the central focusing element and side wall comprise an acrylate polymer or polycarbonate plastic.

13. The focusing element of claim 12, wherein the annular ring portion comprises an acrylate polymer or polycarbonate plastic, or machined aluminum.

14. The focusing element of claim 13, wherein the annular ring portion is injection-molded.

15. The focusing element of claim 14, wherein the annular ring portion is vacuum metalized.

16. A focusing optic for a flashlight, comprising:
a generally circular lens body having a generally concave front face and a generally convex rear face, wherein the lens body includes:
a central focusing element configured to direct a light beam from an LED in a desired direction, the central focusing element having a convex front surface;
a side wall adjacent the central focusing element, wherein the side wall is configured to form a rear void for receiving the LED, and wherein the side wall is configured to direct the light beam in a desired direction; and
an annular ring portion configured to mate with and extend from the side wall and surround the central focusing element, wherein the annular ring portion is adapted to reflect light from the LED in a desired direction.

17. The focusing optic of claim 16, wherein the side wall and the annular ring portion are discontinuous.

18. A flashlight comprising:
a housing member;
a light source coupled to the housing member;
a power source disposed within the housing member and adapted to provide power to the light source;
a bezel adapted to adjustably couple to the housing member; and
a focusing element adapted to fit within the bezel, wherein the focusing element comprises:
a generally circular lens body having a generally concave front face and a generally convex rear face, wherein the lens body includes:
a central focusing element configured to direct a light beam from an LED in a desired direction, the central focusing element having a convex front surface and a rear surface;
a side wall extending from the central focusing element, wherein the side wall is configured to form a rear void for receiving the LED, and wherein the side wall is configured to direct the light beam in a desired direction; and
an annular ring portion configured to mate with and extend from the side wall and surrounding the central focusing element, wherein the annular ring portion is adapted to reflect light from the LED in a desired direction; and
wherein adjustment of the bezel relative to the housing member adjusts the distance between the rear surface of the central focusing element and the LED within the rear void.

19. The flashlight of claim 18, wherein adjustment of the bezel relative to the housing member alters a focus of a light beam passing through the lens.

20. The flashlight of claim 18, wherein the bezel is adapted to couple to the housing member via a threaded coupling.

21. The flashlight of claim 18, wherein the rear void is sized and shaped to accommodate at least a portion of an LED heat sink member.

22. The flashlight of claim 18, wherein the rear void has a substantially frustoconical shape.

23. The flashlight of claim 22, wherein the LED is coupled to a heat sink, and wherein the heat sink has a substantially frustoconical portion adapted to fit within the rear void.

24. The flashlight of claim 23, wherein the rear void is sized and shaped to allow a distance between the rear surface of the central focusing element and the LED to be adjusted.
